(19) United States
(12) Patent Application Publication
(10) Pub. No.: US 2017/0161238 A1
(43) Pub. Date: Jun. 8, 2017

(54) EMOJIS FOR REDIRECTING USER TO DESIRED WEBSITES

(71) Applicant: Gary Fang, Inglewood, CA (US)

(72) Inventor: Gary Fang, Inglewood, CA (US)

(21) Appl. No.: 15/367,429

(22) Filed: Dec. 2, 2016

Related U.S. Application Data
(60) Provisional application No. 62/262,952, filed on Dec. 4, 2015.

(51) Int. Cl. G06F 17/22; G06F 3/0482; G06F 3/023; G06F 17/27

(52) U.S. Cl. CPC G06F 17/2235; G06F 17/2765; G06F 17/2735; G06F 3/0482; G06F 3/0237

(57) ABSTRACT

The invention relates to a unique user interface for support on navigating addresses worldwide. The system comprises of method for analyzing, predicting and suggesting emoji based on input characters to the user. The user can select the most relevant emoji and accordingly linked it to any specific web-address to get redirected to the desired website or portals worldwide or locally located portals. A method for doing this is also mentioned.

### CROSS REFERENCE TO RELATED APPLICATION

This application is a detailed reply of USPTO letter related to U.S. Non-Provisional application Ser. No. 15/367,429 filed on Dec. 2, 2016 under “Extended Missing Parts Pilot Program” having title “EMOJIS FOR REDIRECTING USER TO DESIRED WEBSITES” “ and claims priority to and the benefit of U.S. Provisional Patent Application No. 62/262,952, filed Dec. 4, 2015; the disclosure of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### TECHNICAL FIELD

Embodiments described herein relate to electronic communication based on computing devices. More particularly the embodiments relate to electronic or computing devices that provide hyperlinked emoji characters for electronic texts and documents. Further, the embodiments also describe various characteristics and features of the system which redirects the user to the desired websites after accessing the suggested emoji.

### BACKGROUND

Increase in industrialization and commerce has crowded the electronic media with their respective website addresses. The presence of numerous websites or portals worldwide has made it difficult for the electronic media user as well as common public to easily access the desired address or websites. It has become a challenge to access the desired website or portals in the first search attempt on search engines due to availability of numerous websites which might not be relevant to the user and which ultimately consumes time of the user.

Further, the addresses of the websites are also complicated. The availability of phonetically similar websites creates confusion among the user due to which the user is not able to navigate to the desired website or portals. It has become a big challenge to create a user interface which will provide easy access to the websites and portals which searched on search engines.

Recently, the use of emoji in the electronic media for the purpose of communications and texts messages has become much frequent. The use of emoji for the purposes of expressing emotions in communication over electronic media is much helpful for the user. Portable electronic devices had been accordingly developed to suit such facilities in order to provide ease in communication by the user. Accordingly, there is a need for such a user interface which would allow emoji suggestions to the user for desired website or portals after analyzing the input characters by the user. The incorporation of emoji into the addresses will not only provide ease of access to the user but it will also provide the user an opportunity to select the exactly similar emoji to access the websites worldwide and locally. The user will he able to locate an option to select the most relevant emoji for specific websites worldwide and for websites locally.

### SUMMARY

An object of the present invention is to provide a system for electronic communication over the internet.

Another object of the present invention is to provide a user interface for the user to search and locate the exact relevant websites.

A further object of the present invention is to provide a user interface which will predict and suggest the most relevant emoji to the user based on the input characters to linked with corresponding website addresses. Further, the suggested most relevant emoji to the user for corresponding locally available portals based upon the location and search of the user depending on the location, browsing history and other parameters.

A further object of the present invention is to create and manage a relation between the characters or text and a plurality of emoji.

Yet another objective of the present invention's to provide a method to link at-least a web-address to an emoji. Further, the facility of making the linked at-least a web-address permanent to an emoji is also described.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 illustrates a system includes a method for suggesting emoji and redirecting the user to specific websites, websites worldwide and local based markets based on the input characters by the user;

FIG. 2 illustrates a method of the system for inputting standard texts input by the user to get specific emoji;

FIG. 3 illustrates the method under the present system provides direct link to the different sections of the websites;

FIG. 4 illustrates the method under the present system to create temporary or permanent emoji based link.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and component comprising one unit and elements or components that comprise more than one unit unless specifically stated otherwise.

The above noted and other objects, in one aspect, may be achieved by a method or a system of the present disclosure. The system includes a method for suggesting emoji and redirecting the user to specific websites, websites worldwide and local based markets based on the input characters by the user.

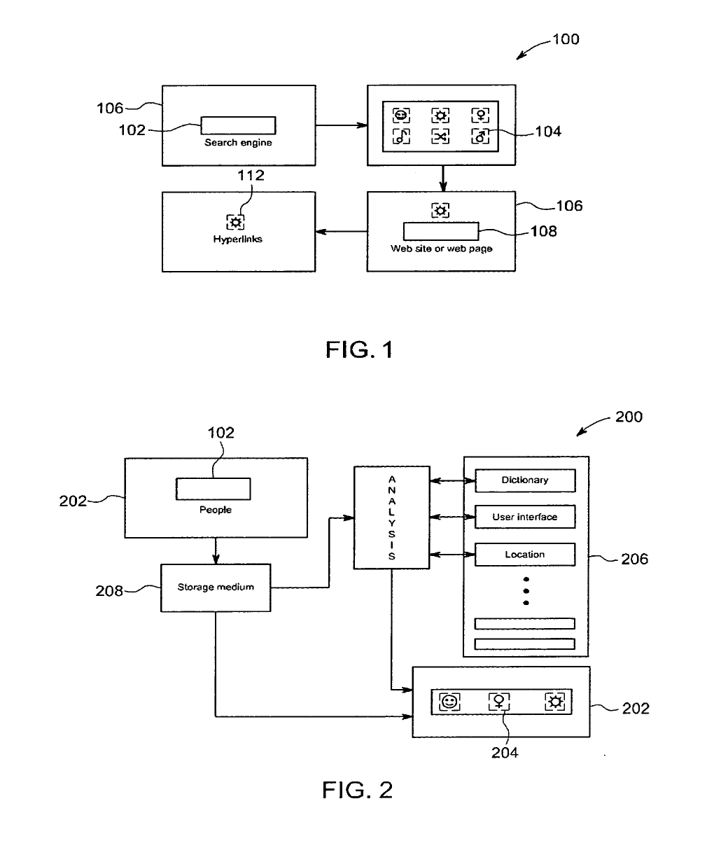

The method as described in FIG. 1 herein comprises provision 100 for the users to enter the desired characters in words or numerals in the search engine 102 of the computing interface 106. The method further analyzes the input characters of the user and accordingly suggests various relevant emoji 104 for selection to the user. Once the user selects the emoji and hits the same, accordingly the user will be re-directed to an interface 106 to facilitate the linking of the selected emoji to the desired websites or webpage 108 which may be either specific websites, websites worldwide or to the addresses which are located locally.

The method of the present invention requires the user to input characters in the search engine 102 which may be letters or numerals. Once the characters are input into the search engine, the system analyzes the characters as shown in 200 and accordingly suggests relevant emoji to the user. The method comprises features of suggesting more than one emoji 104 to the user which provides the opportunity to select the most relevant emoji to their search.

After the emoji are selected to the user and once the user selects the emoji, the system incorporates the selected emoji corresponding to the address or characters as shown by interface 106. The selected emoji to the corresponding address redirects the user to the different addresses as per user's choice. The system after incorporation of the emoji into the addresses redirects the user to the desired address worldwide. The user can click on the hyperlinked or linked emoji 112 as shown in screen 106 and get redirected to the desired websites worldwide and accordingly the system does not require input of the complete address by the user for getting redirected to the desired websites. The selected emoji's under the present system is capable of redirecting the user to specific websites worldwide or any specific page of a web-address or websites situated locally as per the requirements of the user.

FIG. 2 showcased the method of the system preferably detects standard texts input by the user using specific emoji settings. The system 200 is capable of detecting texts in various languages and suggests the relevant emoji accordingly. The system 200 detects texts in various languages for suggesting the emoji for websites worldwide or any specific page of a web-address or websites situated locally. The input characters are analyzed based on the characters dictionary meaning, user browsing history, user location information etc and accordingly the system suggests relevant emoji options 204 to the user for selection and incorporation to the corresponding address. The system suggests more than one emoji to the user so that the user can select the most relevant emoji to get redirected to the websites.

The system 200 is capable of providing services to the user based on different servers. The method comprises suggesting the emoji to the user for specific websites, websites in general worldwide and the local market based addresses. The user will have to input the characters and accordingly the system will predict and suggest the emoji based upon the usage history by the user and the location of the user if the user requires any specific website worldwide and accordingly inputs the characters then the system will suggest the specific address to the user. The user will have the opportunity to select the most relevant emoji suggested by the system.

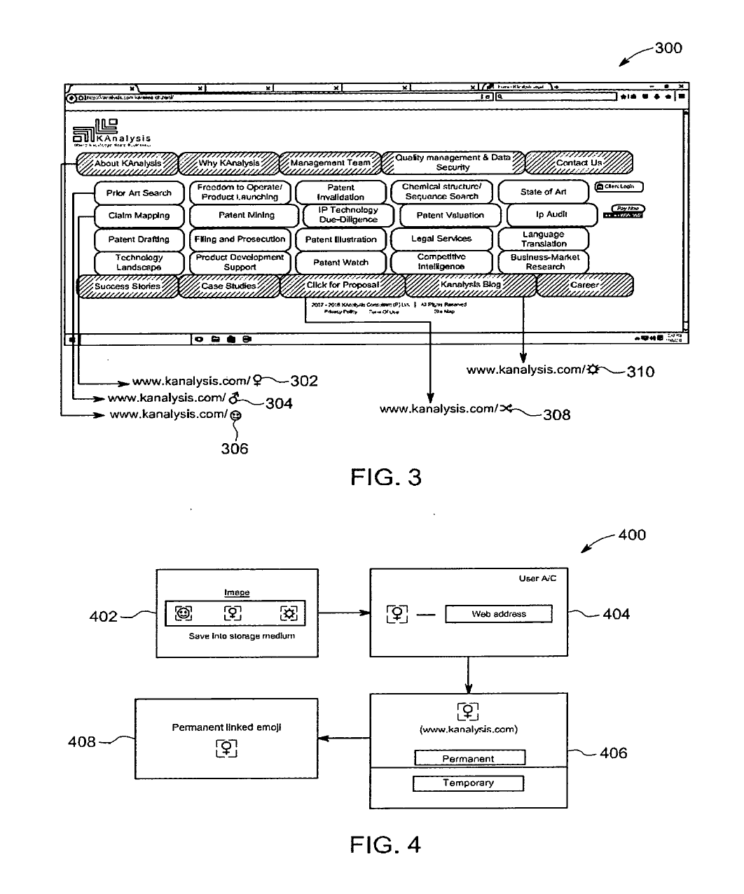

FIG. 3 showcases the method under the present system provides direct link to the different sections of the websites worldwide 300. The user's input of characters into the system predicts and suggests the user emoji related to the different sections of the website and the user will have the opportunity to select the relevant emoji for desired section of the website wherein after the incorporation of the relevant emoji to the address the user will he redirected to that specific section of the website. For example, a global website www.kanalysis.com has a number of webpages for showcasing different part or services of this firm as mentioned in the table below:

TABLE 1

| | |
|---|---|
| www.kanakysis.com/about | For About US page |
| www.kanakysis.com/priorartsearch | For Prior Art Search Service Page |
| www.kanakysis.com/claimmapping | For Claim Mapping Service Page |
| www.kanakysis.com/blog | For Blog Page |
| www.kanakysis.com/proposal | For Proposal Page |

By generating the emoji for the text/character about, priorartsearch, claimmapping, blog and proposal, the related webpage can be modified to

TABLE 2

| | |
|---|---|
| For About US page | www.kanakysis.com/EMOJI1 (302) |
| For Prior Art Search Service Page | www.kanakysis.com/EMOJI2 (304) |
| For Claim Mapping Service Page | www.kanakysis.com EMOJI3 (306) |
| For Blog Page | www.kanakysis.com/EMOJI4 (308) |
| For Proposal Page | www.kanakysis.com/EMOJI5 (310) |

The user further can save, by using the interface 402, any specific emoji or logo to the storage medium 104 and linked it to specific websites worldwide or any specific page of a web-address or websites situated locally, temporarily or permanently too as per 406. For example, the user can save any firm logo, linked it to any web-address (404) and marked it permanent as shown in FIG. 4. Once the linked emoji or logo is marked as permanent, it will not be assigned to another user. Further, the user can use this permanent link as the main or parent web address for related web-pages linked to that web-address. For example, if the user has generated a permanent emoji (EMOJI) for the web address www.kanalysis.com or linked an emoji to any web-address and marked that linked emoji or logo as permanent, the user can use the same emoji as the parent web-address link for related webpages as EMOJI/EMOJIl for www.kanakysis.com/about page where EMOJI is for www.kanalysis.com domain and EMOJI for its about-us page.

The system comprises of storage medium 208 for storing the input characters of the user's in order to perform the prediction and suggestion of the emoji to the user. The storage stores the history of the texts and emoji's used by the user to best predict and suggest the emoji to the user. The system comprises method for identifying the characters based on various dictionaries to perform the best prediction and suggestion to the user.

The system stores the preferential data inserted by the user to detect and suggest the emoji to the user. The method comprises provision of storing and accessing the location of the user to suggest the emoji to the user which will redirect the user to the desired websites worldwide or locally based upon the search and location of the user.

In one of the preferred embodiment, the present system redirects the user to the desired address as well as addresses based on local markets.

In one of the preferred embodiment, the method comprises of analyzing the text inserted by the user and predicting and suggesting the relevant emoji to the user.

In one of the preferred embodiment, the method preferably detects standard texts input by the user using user specific emoji settings, capable of detecting and suggesting texts in various languages, capable for detecting input texts and analyzing relevant emoji at local level and also at worldwide.

In one of the preferred embodiment, the method is capable of adjusting in separate servers as per the requirements, suggests the most relevant emoji to the user based upon the usage by the user.

In one of the preferred embodiment, the emoji redirects the user to a specific website as per the user's requirements.

In one of the preferred embodiment, the method is capable of characterizing and suggesting emoji's for specific websites, for websites worldwide and also for addresses which are located locally, the emoji is suggested as per the location of the user and input of the characters by the user.

In one of the preferred embodiment, the method suggests relevant emoji to the user for different sections of the websites on worldwide web, specific websites and portals comprising local market details.

In one of the preferred embodiment, the system is capable of storing the location of the user and accordingly provides the emoji to redirect the user to the desired websites worldwide, specific websites or local market addresses.

What is claimed is:

1. A method for creating emoji based hyperlink comprising:
a. entering of characters in words or numerals in a search engine;
b. analyzing and shorting the characters;
c. suggesting at-least one relevant emoji for selection relating to the entered characters;
d. incorporating a selected emoji to a corresponding address or characters;
e. facilitating a user to get redirected to different addresses; and
f. redirecting any user by clicking on the selected emoji incorporated addresses local or global websites or webpages.

2. The method as claimed in claim 1 analyzes the characters entered by the user, predict and suggests the relevant emoji to the user.

3. The method as claimed in claim 1, wherein the method preferably detects standard texts input by the user using user specific emoji settings.

4. The method as claimed in claim 1, wherein the method is capable of detecting and suggesting texts in various languages.

5. The method as claimed in claim 1, wherein the method is capable of adjusting in separate servers as per requirements.

6. The method as claimed in claim 1, wherein the method suggests a list of relevant emoji for selection to the user based upon the entered characters, historical data and surfing data of the user.

7. The method as claimed in claim 1, wherein the emoji incorporated address redirects the user to a specific webpage or website.

8. The method as claimed in claim 1, wherein the method is capable of characterizing and suggesting emoji for specific webpage of worldwide websites and local websites separately.

9. The method as claimed in claim 1, wherein the emoji is suggested as per location data of the user.

10. The method as claimed in claim 1, wherein the emoji is suggested as per the entered characters by the user.

11. The method as claimed in claim 2, wherein the suggested emoji incorporated address is linked to any specific webpage or website.

12. The method as claimed in claim 10, wherein the method suggests emoji to the user for different sections of the webpage on worldwide web, local web and portals.

13. A system to perform suggestions of emoji to a user comprising:
a. an interface for entering characters by the user;
b. a storage medium for storing a plurality of emoji;
c. a database for managing relations or preferential relations between the entered characters and stored emoji;
d. a processor to process the entered characters; and
e. an output unit to out the suggested emoji to the user as per the entered characters for further action by the user.

14. The system as claimed in claim 13, wherein the system identifies the entered characters based on various dictionaries and accordingly relate it to the stored emoji.

15. The system as claimed in claim 13, wherein the system relate the entered characters to at-least one stored emoji.

16. The system as claimed in claim 13, wherein the system stores a list of preferential information inserted by the user to detect and suggest one or more relevant emoji to the user.

17. The system as claimed in claim 13, wherein the system is capable of storing dynamic location information, historical data, surfing behavior of the user and accordingly provides the emoji to incorporate into an address of any webpage or websites.

18. The system as claimed in claim 13, wherein the system is used to open an emoji incorporated address for accessing any linked webpages or websites.
